(19) United States
(12) Patent Application Publication
(10) Pub. No.: US 2023/0098800 A1
(43) Pub. Date: Mar. 30, 2023

(54) AUTOMATED MEASUREMENT AND ANALYTICS SOFTWARE FOR OUT OF HOME CONTENT DELIVERY

(71) Applicant: Accretive Media LLC, Manhattan Beach, CA (US)

(72) Inventor: Craig G. Benner, Manhattan Beach, CA (US)

(73) Assignee: Accretive Media LLC, Manhattan Beach, CA (US)

(21) Appl. No.: 17/935,464

(22) Filed: Sep. 26, 2022

Related U.S. Application Data
(60) Provisional application No. 63/248,176, filed on Sep. 24, 2021.

(51) Int. Cl. G06Q 30/02

(52) U.S. Cl. CPC G06Q 30/0244; G06Q 30/0201; G06Q 30/0205

(57) ABSTRACT

A method and system provide the ability to deliver media content. Input data is ingested and includes raw data for household locations and marketing data. The input data further consists of physical out-of-home activity data from advertisement exposure and business points of interest visitation, and digital internet based online activity data. The ingestion is performed through a pre-setup process that identifies a data delivery format, a data schema, and a linking key used in a Graph within a database. The input data is processed by determining when new data is ready for ingestion, identifying a file source, extracting the input data from the file source, and importing and storing the extracted input data into the Graph using the key. The input data is linked in the Graph. Measurements and analytics are generated and provide a measurement of exposure to and effectiveness of delivered media content.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/248,176, filed on Sep. 24, 2021, with inventor(s) Craig G. Benner, entitled “Automated Measurement & Analytics Software for Out-Of-Home Advertising,” attorneys' docket number 295.0006USP1.

### BACKGROUND OF THE INVENTION

### 1. Field of the Invention

The present invention relates generally to media content delivery, and in particular, to a method, system, apparatus, and article of manufacture to measure and analyze the strength, influence and effectiveness of media content delivered to users outside of their home.

### 2. Description of the Related Art

Today's digital and traditional advertising struggles to truly connect with consumers. In an overly complicated advertising ecosystem, media providers either cast too wide a net or are way too intrusive, turning off consumers. There are many different types and methods utilized to digitally connect with consumers, ranging from delivering media content (e.g., advertisements) via web pages (to browsing users) on personal devices (e.g., on home computers and/or on mobile devices) to billboards and signs near roadways, bus stops, public venues, etc. However, to impactfully deliver meaningful content, it is desirable to measure and track user interactions/conduct both when at home and on out-of-home screens. To better understand such problems it may be useful to describe prior art measurement and media content delivery methods.

Generally speaking, digital (“online”) consumer activity occurs over a series of HTTP (Hyper Text Transfer Protocol) Requests and Responses to and from web server(s). The request(s) to access resource(s) on a web server are commonly made with the purpose of retrieving data from a web server for the display of content, to send data to the web server for tracking or storing, and other online functionality.

HTTP Requests contain information about the device and the network in which the request originated from. Common information includes a timestamp of the request, an external IP (Internet Protocol) address the request originated from, and if from a mobile device, a mobile device identifier. Based on the IP address, actions arising from and associated with that IP address may be tracked (i.e., by the web server) and used to further target media content to requests originating from that IP address. When HTTP requests originate from the same physical premises (and therefore the same IP address associated with a home or office), advertising and analytics of the actions associated with the HTTP request may be more easily conducted compared to requests from unknown IP addresses or publicly used IP addresses (e.g., screens at public venues, internet café computers, airport networks, etc.). Thus, when a user is traveling outside of the home, it is difficult, if not impossible to properly identify that user. In this regard, prior art systems fail to provide the ability to identify and utilize information to measure and target media content to consumers both in an out-of-home and in an intelligent impactful way. In other words, it is desirable to provide a system that balances intelligent measurement and targeting with mainstream appeal while leveraging rich deterministic information to make outdoor messages effective, impactful, and targeted.

### SUMMARY OF THE INVENTION

Embodiments of the invention provide a method, apparatus, system, computer readable storage, and computer program that connects events and actions in and among the physical (“out-of-home”) ecosystem with events and actions in and among the digital (“online”) ecosystem to measure and create analytical reporting models, optimization, and targeting for out-of-home media content providers (e.g., advertisers).

Embodiments of the invention gather or determine “out-of-home” consumer advertising exposure events, including from traditional static screens and digital out-of-home screens, advertiser business location (“foot traffic”) actions, and other business related actions from geo-temporal mobile location data, direct mobile device engagements such as WiFi, blue-tooth, and other methods.

Embodiments of the invention gather or determine “online” outcomes such as online website or app visitation, sign-ups, and sales data on applicable advertiser digital business properties from visitation log files, tracking pixels, and other sources.

Embodiments of the invention combine and link advertiser's related “out-of-home” data, advertiser's applicable “online” data, and any other offline, physical, or digital relevant data using an out-of-home matching “Graph” database linking data sources mainly by household identifiers (such as non-commercial physical addresses, non-commercial mapped IP addresses) and mobile device identifiers.

Embodiments of the invention use data to generate advertising effectiveness metrics and outcomes. Processes may include randomized controlled trial methodology and modeling to determine lift calculations (percent increase in business metrics as a result of exposure to advertising) for the purpose of out-of-home advertising effectiveness measurement, optimization, and audience targeting.

### BRIEF DESCRIPTION OF THE DRAWINGS

Referring now to the drawings in which like reference numbers represent corresponding parts throughout:

FIGS. 1A and 1B illustrate the general workflow for processing data to connect the physical out-of-home ecosystem with the digital online ecosystem to generate data, measurements, and models for optimizing and targeting media content in accordance with one more embodiments of the invention;

FIG. 2 illustrates an exemplary reach and frequency analysis graphical user interface/report generated in accordance with one or more embodiments of the invention;

FIG. 3 illustrates an exemplary web lift report graphical user interface/report generated in accordance with one or more embodiments of the invention;

FIG. 4 illustrates an exemplary return on ad spend graphical user interface/report generated in accordance with one or more embodiments of the invention;

FIG. 5 illustrates a foot traffic report/graphical user interface generated in accordance with one or more embodiments of the invention;

FIG. 6 illustrates the logical flow for delivering media content in accordance with one or more embodiments of the invention;

FIG. 7 is an exemplary hardware and software environment used to implement one or more embodiments of the invention; and

FIG. 8 schematically illustrates a typical distributed/cloud-based computer system in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

Methodology

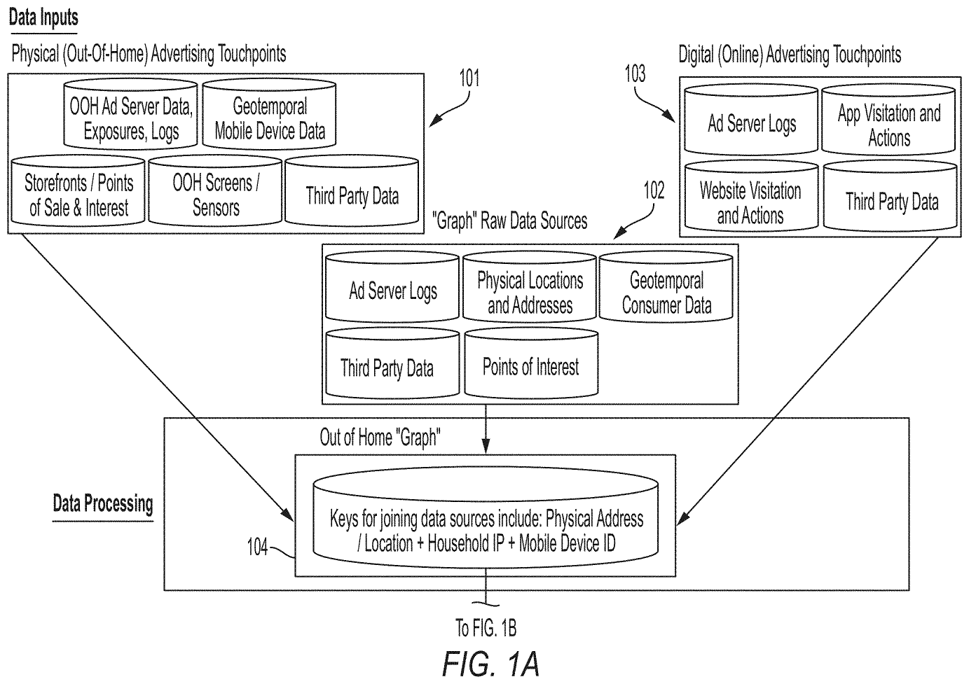

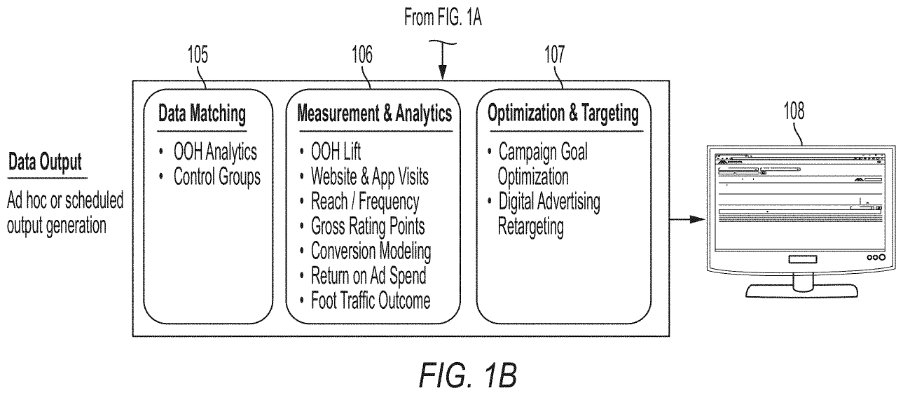

Embodiments of the invention provide the ability to connect events and actions in and among the physical (“out of home”) ecosystem with events and actions in and among the digital (“online”) ecosystem to measure and create analytical reporting models optimization and targeting for out of home media content producers/providers (e.g., advertisers). FIGS. 1A and 1B illustrate the general workflow for processing data to connect the physical out-of-home ecosystem with the digital online ecosystem to generate data, measurements, and models for optimizing and targeting media content (e.g., advertisements) in accordance with one more embodiments of the invention.

Generally, the workflow provides data inputs 101-103 that can be joined/stored/processed via Graph 104. The Graph 104 processing of the data can further be used to generate output data 105-107 that is delivered/presented on a graphical user interface 108. Each of the different components 101-108 are described in further detail below.

Data Inputs 101-103

Physical (Out-of-Home) Advertising Touchpoints 101

The physical out-of-home data 101 is data sourced from observation and direct consumer engagement behavior of advertiser touchpoints based on physical locations including advertisement locations, storefronts and/or point of sale and other applicable locations. Ad locations are commonly, but not limited to, traditional static screens and digital out-of-home screens. Storefronts/Point of Sales/Point of Interest are commonly, but not limited to, retail locations, and areas of operation.

Data sources for the physical out-of-home touchpoints 101 include, but are not limited to:
Out-Of-Home or other Ad Server data from log files and other means identifying the ad delivery information (location, time, duration, etc.).
Consumer exposure based on analysis of geotemporal data (location, direction, bearing, dwell time) and other indirect data from beacons, WiFi access points, etc. Consumer data is paired with data about the physical locations (for ad criteria such as screen size, screen direction, location, and ad duration) to be able to statistically determine exposure and/or store and point of interest visitation.
Direct consumer engagement data (e.g., scanning QR code on advertisements, using coupon at time of purchase, etc.).
Third Party data sources include, but are not limited to tune-in data from Smart TVs, automotive sales data from the DMV (department of motor vehicles)/dealer DMS (dealership management software), anonymized credit card data from retailers, UPC-level (universal product code level) transaction data from loyalty programs, and other privacy-compliant sources capable of linking to the Graph 104.

In view of the above, physical (out-of-home) data 101 (e.g., advertising touchpoints) is useful for advertisers to determine “foot traffic” visits to locations of interest including point of sale locations and storefronts, and also exposures to out-of-home advertisements including billboards and other out-of-home placements. Physical data 101 can be obtained through mobile device geotemporal data, wifi access points, bluetooth or other sensors, direct interactions such as scanning QR codes, using coupons, etc. that contain a key (commonly a mobile device identifier) or secondary key (such as physical address) to link the activity in and amongst other advertiser activity.

In one or more embodiments, geotemporal mobile device data may be automatically analyzed through a process to determine the statistical likelihood the mobile device user visited an advertiser location or whether the user was exposed to an advertiser's out-of-home advertisements. Such analysis utilizes criteria that statistically validates the location (latitude, longitude) of the device, the bearing, timing, dwell time, and takes into account the size and location of the ad, the ad duration, the ad placement direction, etc.

“Graph” Raw Data Sources 102

Data related to physical and digital touchpoints enabling the joining of physical and digital advertising data. This includes, but is not limited to, household identifiers such as IP address (non-commercial Internet Protocol Address determined to statistically map to an individual household with a high degree of certainty), physical address, and primary mobile device identifiers.

The Graph raw data sources 102 enable the ingestion of all individual data sources to be joined together based on common identifiers such as IP Address, mobile device identifier, physical address, latitude and longitude coordinates, etc. to create one large, combined dataset to process advertiser computations against in order to produce measurements and statistical results related to advertiser's out-of-home advertisement effectiveness and general holistic data related to advertiser's campaigns.

Data is commonly available from ad server log files (containing timestamp, IP address, mobile device identifier), consumer provided marketing information (e.g., geotemporal consumer data), points of interest, as well as public and third party data sets of physical locations, latitude and longitude coordinates, physical addresses, and census based demographic data.

Digital (Online) Advertising Touchpoints 103

Digital online advertising touchpoints 103 consist of data sourced from consumer digital engagement activity via advertiser's websites and mobile and/or connected device app or SDK (software development kit) log files, tracking pixels, or via third party tracking sources, all of which at a minimum must include timestamp, IP address and/or mobile device identifier, or another common Graph matching key and the event or activity completed (such as website visit, app download, sale or signup, etc.).

Digital data 103 is useful for advertisers to qualify and quantify consumer actions of interest online including the type of actions and events such as website or “application” (mobile, connected TV, etc.) visits, application “app” downloads, online purchases, information requests, sign ups, etc.

Digital data 103 can be sourced from advertisers placing tracking pixels on their digital properties to track applicable actions and events, or by using web server access logs from their digital properties that identify and record applicable events, or from third parties with capabilities and data to track consumer activity on the advertiser's digital properties for applicable events. Such data must contain at least one Graph key (such as IP Address), timestamp of activity, and the denote the type of activity (example: consumer purchase on website).

Data Processing

Overview

The data inputs 101-103 are processed via the out of home “Graph” 104. In this regard, the out of home Graph 104 includes processes for all the individual data input sources 101-103 to be linked together based on common identifiers such as IP address, mobile device identifier, physical address, latitude and longitude, etc. to create one large, combined master dataset.

The Graph dataset enables processing advertiser based computations against the full Graph dataset of all joined data input sources 101-103 in order to produce measurements and statistical results related to an advertiser's out-of-home advertisement effectiveness and general holistic data related to advertiser's campaigns.

Graph data inputs 101-103 can be added and updated at any time and the Graph full data set for computation is available for real time computations or scheduled analysis.

Details

The system and software programs create and continually update the Graph 104 which is an essential relational database and accompanying processes to “ETL” (Extract, Transform, Load) raw data (e.g., raw data 102) into the database that enables connecting physical (“out-of-home”) data 101 and digital (“online”) data 103 (along with raw supporting data 102), events, actions and events, and the processes to compute measurements and statistical analytics for out-of-home advertisers.

With a large, continually updated, data store of online activity from sources such as web browsing data and advertising delivery data, the Graph ETL processes can analyze and group mobile device identifiers and link IP addresses in order to ascertain the primary home (“Household”) IP address of any mobile device identifier based on primary and most recent activity thresholds with filters including non-commercial based IP addresses and activity time of day.

These two “keys” (household IP address and mobile device identifier), along with others, enables the ETL, joining, and storage in the Graph 104 of data sources that contain at least one of the keys and provides the support for adding additional keys all stored under a “Household” primary hierarchy. For example: if a data source at least has an IP address and activity timestamp (this is very likely for server logs or web event tracking outside of any kind) then all the activity can be linked to a household and among the mobile devices of the household. Also, for example, if a data source only has a mobile device identifier (this could be from geotemporal data tracking sources, mobile application data, wifi access points, etc.), all the activity can be stored for the mobile device and linked to the household that contains the mobile device. Therefore, any digital actions and events completed by the household and any mobile out-of-home actions and events completed by the household can be linked.

The Graph 104 is not limited to using a household IP address and mobile device identifier to join data from physical 101 and digital 103 data sources. These keys are largely utilized today due to their common presence in digital (IP address) and physical (mobile device identifier) data sources. Over time, as Internet Protocols and device tracking evolves, new keys can be utilized for the same purposes.

The Graph 104 data is consistently refreshed to prevent staleness and statistical inaccuracy. It will detect a change in any household IP address due to reasons such as people moving, IP address rotation, etc.) or other statistical anomalies in keys that require Graph 104 updates to maintain accuracy.

Supplemental data regarding consumer and household interests, purchases, demographics, etc. can be added using any of the household keys or linked device keys or on “secondary keys” such as by using geotemporal and mobile device identifier data to determine a physical address and then using the physical address to link third party marketing data, census data, etc.

The Graph 104 is intended to store data and link physical and digital activity that is relevant to advertisers, and more specifically “out-of-home” advertisers.

The Graph 104 enables process to run to generate measurements and analytics for out-of-home advertisers to independently analyze and jointly analyze physical and digital data to create a holistic view of consumer exposure to ads (including reach, frequency, and gross rating points, etc.), conversion activity post exposure (location visits, purchases, leads, website and app visits, etc.), overall campaign and granular advertisement placement effectiveness, out-of-home advertising lift (increase in sales or other goals), return on investment, etc. Any measurements and analytics can be viewed over specific periods of time, and utilize predefined and custom “lookback windows” (the time between advertisement exposure and subsequent action).

Data Output 105-107

In view of the above, the Graph 104 generates output data 105-107 on an ad hoc or scheduled basis. Such output data may include data matching 105, measurement and analytics 106, and optimization and targeting data 107. In general, data matching 105 may include out-of-home analytics and control groups. Measurements and analytics 106 may include OOH lift, website and app visits, reach/frequency, gross rating points, conversion modeling, return on ad spend, and foot traffic outcome. Further, optimization and targeting 107 may include campaign goal optimizations and digital advertising retargeting. Further details regarding the data outputs 105-107 are described below.

The data measurements and analysis 106 are presented in robust reports and made available in a user interface 108 online for easy to view consumption and download.

Data Matching 105

Data Matching 105 is the process of matching consumers exposed to out-of-home advertisements (e.g., via the physical out-of-home advertising touchpoints 101) with Graph data keys in order to join other Graph data. In this regard, the Data Matching 105 provides OOH analytics. Such data matching 105 may also include the process for establishing control groups such as randomized and similarity control groups for comparing metrics against consumers exposed to an advertiser's out-of-home advertisements and those not exposed. Randomized control groups may be randomly selected nationwide audiences with similar demographic and psychographic profiles of the exposed population being measured. Similarity control groups are market level audiences with similar demographic and psychographic profiles of exposed population being measured.

Further to the above, the Graph data output processing (i.e., at step 104) generates statistically relevant sized control groups of consumers to identify consumer activity of non-exposed consumers compared to the advertiser's campaign exposed consumers for comparison of calculated metrics such as lift in advertising effectiveness.

Measurement and Analytics 106

Utilizing the Graph 104 database, advertiser specific statistical analysis and accompanying measurement metrics are produced in real time or scheduled. In addition to basic measurements, Graph computations and measurements include, but are not limited to the following:
“Attribution” of certain actions (such as a sale or information requests) to the advertiser's campaign based on knowing the consumer that created the action was exposed to the campaign or not, when they were exposed to the campaign and when the action occurred (statistical likelihood the advertisement exposure was a part of driving the action) (i.e., attribution based on website and app visits).
“Lift” (aka OOH Lift) of any action (website visit, store visitation, etc.) vs. a Control Group (various control groups created for different statistical analysis such as non-exposed advertisement consumers in or out of the same target geographical area as exposed advertisement consumers) showing increase in business metrics as a result of exposure to advertising for the purpose of advertising effectiveness measurement.
“Reach and Frequency” of the advertiser's campaign including statistically relevant measurement of how many consumers were exposed to the ads and how many ads of the campaign they were exposed to.

Measurements and Analytics may be calculated with various “Lookback Days” also known as “Lookback Windows”. The lookback represents how long after an ad exposure to attribute subsequent consumer actions (such as a store visit, website visit, purchase, etc.). For example, for an ad exposure on January 1 at 12 pm with a 3 day lookback window, consider any actions from the exposure time and up to January 4 at 12 pm.

Actions can be custom defined by advertisers or utilize a preconfigured common set such as website visits, app downloads, online purchase, in-store purchase, store visitation (foot traffic). This means advertisers can view out-of-home Return on Ad Spend, Lift and other metrics by any configured action(s).

Measurement and analytics 106 are created at various components and granular levels of out-of-home advertising campaigns including by overall campaign, by creative, by DMA (Designated Market Area), Venue, and Venue Type. This allows for granular and comprehensive insights at all major out-of-home advertising campaign components.

One may note that some measurement and analytics processes 106 may use control groups (i.e., within data matching 105). This is commonly used when computing the effectiveness of an advertisement towards driving a consumer action (“Lift”). Control groups are created using the Graph 104. For example, if an advertiser wants to know the increase in activity (Lift) or return on investment (ROI) of a physical advertisement on a billboard, the process will be to determine a group of exposed consumers and determine a statistically relevant control group of non-exposed users with similar target characteristics (typically using geographic area) and then compare their physical and digital activity (post exposure within a period of time for the exposed consumers) to determine the Lift and ROI from the exposed group as compared to the Control Group.

Some measurement and analytics processes 106 use modeling. For example, the modeling of conversion data to extrapolate consumer acquisition cost and ROI based on mobile penetration and Graph match rates for the advertising campaign. Embodiments of the invention use percentages of mobile device capture and percentage of Graph match to determine a factor in which to model cost-per conversion metrics to bring alignment with other advertising channels.

In addition to/as part of custom measurements and analytics 106, embodiments of the invention may deliver the following core analytics use cases for out-of-home advertising:

Reach and Frequency of Advertising
User selects advertiser, campaign and date range; system produces how many consumers the campaign reached (reach) and how many times (frequency)
System also calculates overall Gross Rating Points (GRPs) and GRPs by market and venue type

Web Visitation and Conversion Analysis and Lift
User selects advertiser, campaign, conversion type (visitation, conversion, etc.), date range, lookback window, control group type; system produces, average time to visit or convert, exposed visitation or conversion, exposed visitation or conversion rate, control visitation or conversions, unexposed visitation or conversion rates, rates and lifts overall, by market, by venue type and by venue in market

App Download and Conversion Analysis and Lift
User selects advertiser, campaign, conversion type (download, purchase, etc.), date range, lookback window, control group type; system produces exposed downloads or conversion, average time to download or convert, exposed downloads or conversion rate, control downloads or conversions, unexposed downloads or conversion rates, rates and lifts overall, by market, by venue type and by venue in market

Cost Per Web Visit, Cost Per Sale, Return on Ad Spend Analysis
User selects advertiser, campaign, date range, lookback window; system produces visits and conversions, modeled visits and conversions, total campaign cost, cost per visit, cost per conversion—overall, by market, by venue type and by venue in market

Foot Traffic Outcome (Analysis and Lift)
User selects advertiser, campaign; system produces total store visits, average distance traveled to store, exposed store visits, control store visits, exposed visitation rate, unexposed visitation rate, foot traffic lift overall, by market and by venue in market

Consumer Packaged Goods ROI and Sales Lift
User selects advertiser, campaign, date range; system produces attributable CPG sales and lift—overall, by market, by venue type and by venue in market

Third Party Data Event Analysis and Lift
User selects advertiser, campaign, date range; system produces attributable third party data event percentage and lift—overall, by market, by venue type and by venue in market

In addition to measurement and analytics 106, the Graph processes will automatically create pure mobile device IDs (MAIDS) from advertiser's out-of-home campaign exposure data (i.e., from physical advertising touchpoints 101) for retargeting (follow-up advertising to a group consumers) on mobile, social and other digital platforms. The system will automatically convert exposed mobile devices into a format that is available for retargeting on major digital demand side platforms and social media networks for targeting 107 of the consumers. Included are translation to APPLE IDs, ANDROID IDs, household IPs, etc.

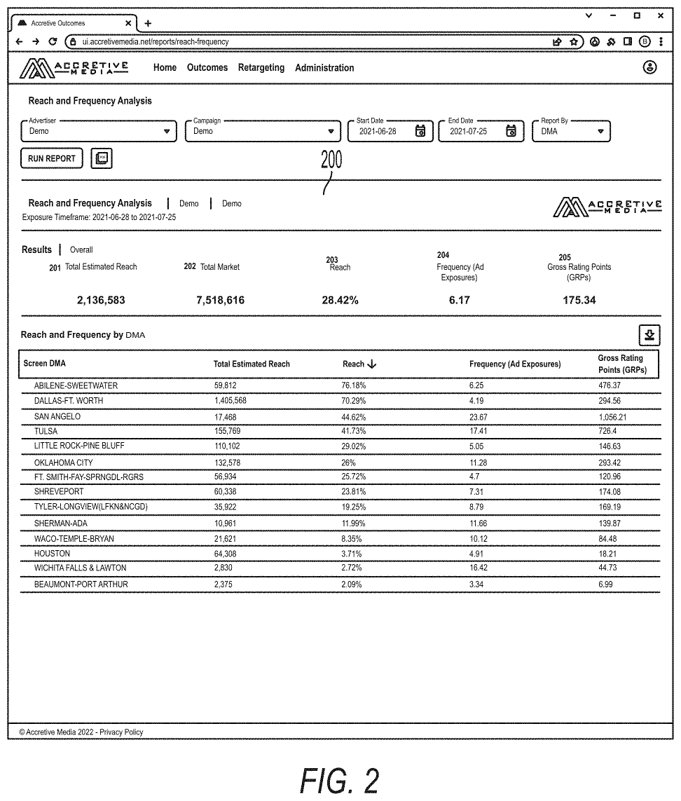

FIGS. 2-5 illustrate exemplary measurements and analytics reports generated and provided to advertisers with the use of the Graph 104 for an Out-of-Home advertising campaign in accordance with one or more embodiments of the invention.

FIG. 2 illustrates an exemplary reach and frequency analysis graphical user interface/report generated in accordance with one or more embodiments of the invention. Such a reach and frequency analysis 200 may include the Total Estimated Reach 201 which provides the total unique number of consumers exposed (extrapolated using exposure data modeling). The reach and frequency analysis 200 may also include the Total Market 202 which provides the addressable market size of all the geographical areas that the ad campaign was targeted to. Further data provided may include the Reach 203 representing the percentage of the Total Market who was exposed to the campaign's ad(s). The Frequency (Ad Exposures) 204 provides the average number of ad impressions an exposed person received for the campaign. In addition, the Gross Rating Points (GRPs) 205 may be provided. The gross rating point (GRP) is a term used in advertising to measure the size of an audience (or total amount of exposures) reached by a specific media vehicle or schedule during a specific period of time. It is expressed in terms of the rating of a specific media vehicle (if only one is being used) or the sum of all the ratings of the vehicles included in a media schedule. It includes any audience duplication and is equal to the reach of a media schedule multiplied by the average frequency of the schedule. The purpose of the GRP metric is to measure impressions in relation to the number of people in the audience for an advertising campaign.

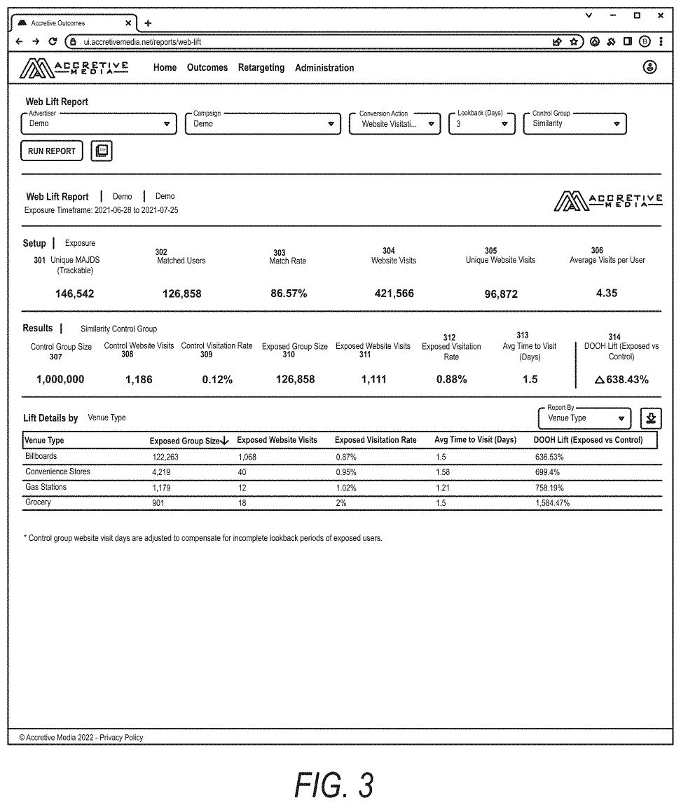

FIG. 3 illustrates an exemplary web lift report graphical user interface/report generated in accordance with one or more embodiments of the invention. The Unique MAIDS (Trackable) 301 indicates the number of unique mobile devices of consumers exposed (and trackable) to an out-of-home advertisement. The Matched Users 302 indicates the number of unique exposed consumers available and linked in the Graph. The Match Rate 303 provides the percent of unique exposed consumers that were matched in the Graph. The Website (or App) Visits and Actions 304 provides the raw number of website (or app) visits and actions during the campaign's ad exposure period (the time in which the out-of-home advertisements were displayed). The Unique Website (or App) Visits and Actions 305 indicates the number of unique consumers or households that visited the advertiser's website (or app) or completed an action during the campaign's ad exposure period. The Average Visits or Actions per Users 306 provides the average number of website or app visits or actions among the consumers or households that visited the website or app or completed an action.

The Control Group Size 307 indicates the size of the control group used to compare the exposed group against for applicable measurements and analytics. The Control Website/App Visits and Actions 308 provides the number of visits and actions from a Control Group consumer or Household. The Visitation (Action) Rate 309 and 312 provide the percentage of group (control 309 or exposed 312) that completed a specific action, such as visited the website or application. The Exposed Group Size 310 indicates the size of the out-of-home advertisement exposed group. The Exposed Web site/pp Visits and Actions 311 reflects the number of visits or actions from an exposed consumer or household. The Avg Time to Conversion 313 provides, for the Exposed Group, the length of time between an ad exposure and action (average time).

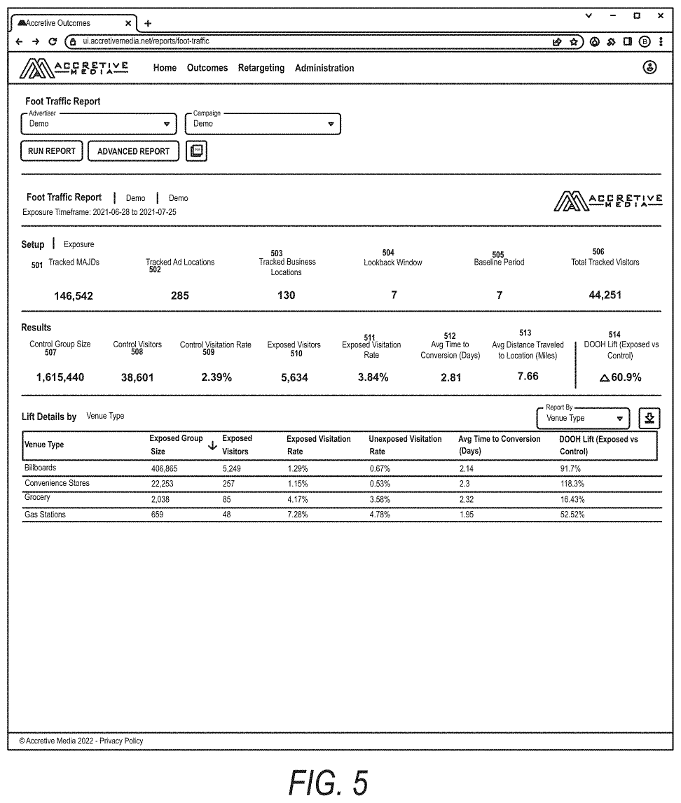

The DOOH Lift (Exposed vs Control) 314 and 514 (see FIG. 5 and description below) provide the percent increase in business metrics as a result of exposure to advertising (comparing a control vs exposed group) for the purpose of advertising effectiveness measurement. The percent increase may be calculated as:

[(Exposed Visitation or Action Rate−Control Visitation or Action Rate)/Control Visitation or Action Rate]×100

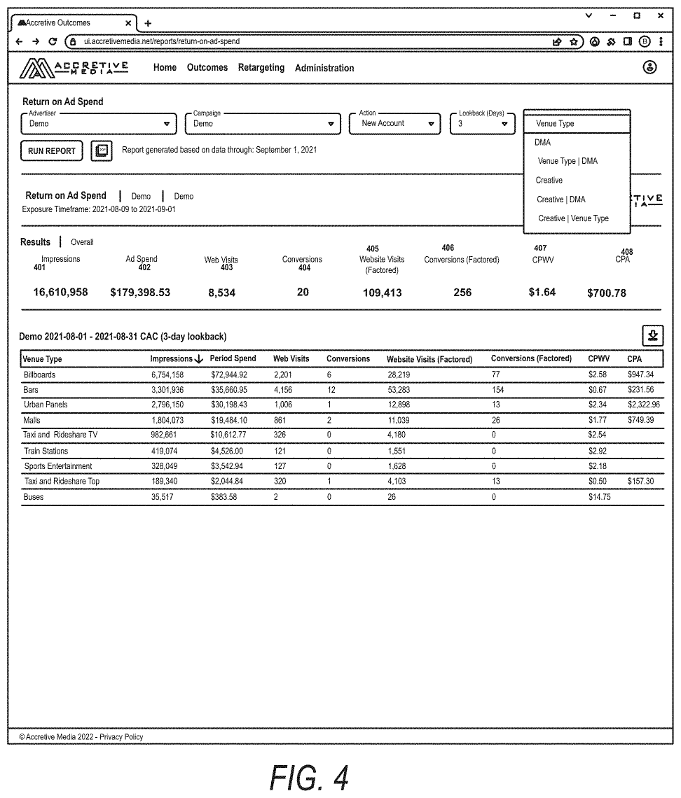

FIG. 4 illustrates an exemplary return on ad spend graphical user interface/report generated in accordance with one or more embodiments of the invention. As illustrated, the Impressions 401 provide the number of ad impressions delivered for the ad campaign. The Ad Spend 402 provides the amount of money spent on the ad campaign by the advertiser. Digital Conversions 404 provides the Web or app based actions (e.g., sales, signups, etc.) from consumers exposed to the advertiser's out-of-home advertisements within the lookback window of the exposure. Website or App Visits (Factored) 405 provides the estimated amount of full out-of-home campaign Website or App visits based on mobile penetration rate, the Match Rate, and the visits from the matched users. Conversions (Factored) 406 provides the estimated amount of full out-of-home campaign Conversions (Actions) based on the Match Rate and the conversions from the matched users. CPWV 407 indicates the Cost per Web Visit that may be computed as Ad Spend divided by Web Visits Factored. CPA 408 provides the Cost per Action that may be computed as the Ad Spend divided by Conversions Factored.

FIG. 5 illustrates a foot traffic report/graphical user interface generated in accordance with one or more embodiments of the invention. The Tracked Ad Locations 502 indicate the total number of tracked locations where Ads were displayed. The Tracked Business Locations 503 provide the total number of business locations where Foot Traffic was measured. The Total Tracked Business Visits 506 reflects the total number of business location visits tracked. The Control Business Visits 508 consists of the total number of business location visits from Control Group. The Control Business Visitation Rate 509 provides the percentage of control group consumers and households that visited a business location. The Exposed Business Visits 510 provides the total number of business location visits from the Exposed Group. The Exposed Business Visitation Rate 511 provides the percentage of exposed consumers and households that visited a business location. The Average Time to Visitation (Days) 512 provides, for the Exposed Group that visited business location(s), the length of time between ad exposure and visit (average in days). The Average Distance Traveled to Location (Miles) 513 reflects, for the Exposed Group that visited business location(s), the average distance (in miles) between exposure location and/or household location.

Optimization & Targeting 107

The Graph system 104 processes will automatically create Targeting segments based on the advertiser's out-of-home consumer exposures for a campaign. For example, for a campaign's exposed mobile device IDs, the Graph generates and formats corresponding Household IP or Household Physical address lists that be used in other forms of targeting advertising including physical mailers to the household address, mobile device ID or household IP address targeting of digital ad campaigns for connected TVs, personal computers, mobile devices, etc., that can be run on social networks, apps, websites, and other ad supported outlets including for “retargeting” (a method of follow up advertising to previously engaged consumers) and further measurement.

Measurements and analytics 106 across the campaign and at various campaign components allows for optimization 107 by adjusting or discontinuing under performing components and gaining insights from high performing components and applying those to other components.

The data measurements and analysis 106 are presented in robust reports (e.g., as described above in FIGS. 2-5) and made available in a user interface 108 online for easy to view consumption and download.

### Logical Flow

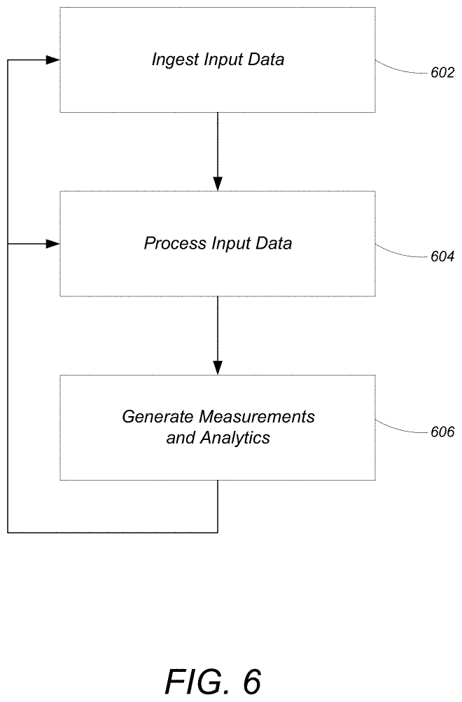

In view of the above, FIG. 6 illustrates the logical flow for delivering media content in accordance with one or more embodiments of the invention.

At step 602, input data is ingested. The ingesting consists of ingesting different types of input data. A first type of input data ingested is raw data which includes: (1) one or more household locations for one or more households, where each household location provides a mapping between a physical street address to global positioning satellite (GPS) coordinates; and (2) marketing data consisting of demographic income and interests data.

A second type of input data ingested is physical out-of-home activity data from advertisement exposure and business points of interest visitation. The ingestion of the physical out-of-home activity data may include normalizing the physical out of home activity data with a mobile device identifier as a key, where the mobile device identifier is for a mobile device.

A third type input data ingested is digital internet based online activity data that may include a timestamp, an event type or action details, and the mobile device identifier or an IP address. Such ingestion may also include normalizing the digital internet based online activity data with the mobile device identifier as the key.

The ingestion of the input data may be performed through a pre-setup process that identifies a data delivery format, a data schema, and the key that will link respective data in a Graph within a central combined relational database.

At step 604, the input data is processed. Such processing may include determining when new data is ready for ingestion based upon polling a file storage location for new files or receiving a notification from a file storage location source that a new file has been added. The processing may also identifying a file source and extract, using the data schema, the input data from the file source. The extracted input data is input and stored into the Graph using the key. Within the Graph (and/or methods of the Graph, the input data is linked. In this regard, the Graph includes: (1) a hierarchy of data keys with a first household of the one or more households at a top of the hierarchy and the mobile device being a child entity of the first household; (2) one or more household attributes for the first household; (3) one or more mobile device attributes, where the mobile device attributes consist of the mobile device identifier and all linked online and physical tracked activity that is ingested into the Graph; and (4) a link between the mobile device and the first household.

At step 606, measurements and analytics, for delivered media content based on the ingested input data, are generated. The measurements and analytics consist of a measurement of exposure to the delivered media content. Further, as illustrated in FIG. 6, based on receipt of new input data, a media content delivery system is iteratively updated and utilized. The media content delivery system delivers the media content based on the measurements and analytics. Further, as illustrated, the measurements and analytics are iteratively updated via the ingestion of the new input data.

Further details regarding the above steps follow. Input data may be ingested, processed, and stored for offline consumer and household location and marketing data (i.e., the raw data described above). In this regard, the household location provides the mapping between physical street address to GPS (latitude/longitude) coordinates for offline data to be ingested, stored, and linked via either attribute. In addition, the marketing data consists of demographic, income, and interests data that may be derived from public census data, consumer purchase and product registration data, tune-in data from Smart TVs, automotive sales data from the DMV/dealer DMS, anonymized credit card data from retailers, UPC-level transaction data from loyalty programs, and other privacy-compliant sources. Such data is used to compute measurements and supplement analysis for out-of-home advertising campaigns.

The data ingestion, processing, and storage steps may also include the ingestion, processing, and storage for physical (out-of-home) activity from advertisement exposure and business points of interest visitation. Further, out-of-home advertisement exposure data links a mobile device to the exposure of an out-of-home advertisement via direct engagement (such as scanning a unique QR code on the advertisement, calling or texting a unique phone number from the advertisement, or visiting a unique website listed on the advertisement) as well as analysis of geotemporal data collected through apps, cellular service providers, WiFi access points, Bluetooth and other beacons and sensors that provide data indicating exposure to an out-of-home advertisement based on ad display time, mobile device proximity to the ad, device bearing toward the ad, device dwell time. Such data collection may be performed using the guidelines from the “DOOH Exposure Methodology Standardization Guidelines and Best Practices” (May 2021) which is incorporated by reference herein.

Business points of interest visitation may also include the visitation of advertiser's storefronts, point of sale, and related business consumer information locations. Visitations, as known as “Foot Traffic”, data comes from direct consumer engagement such as using a coupon at checkout, registering a purchased product, using or signing up for a rewards or loyalty program, providing information such as email address, street address, or phone number for marketing purposes. It also comes from geotemporal mobile device data collected through apps, cellular service providers, WiFi access points, Bluetooth and other beacons and sensors that provide data indicating visitation to a business point of interest based on entering the geofence of the point of the interest and maintaining a time within the geofence sufficient to indicate a visit based on the category of the advertiser (e.g., retail visit must be greater than two (2) minutes).

As described above, the input data may also be normalized with a mobile device identifier as the key and then ingested and stored to compute measurements and join other data sources for analysis of out-of-home advertising campaign performance.

In addition, the input data may be ingested, processed and stored with respect to digital (internet based online) activity. Such digital activity data may include website and app visitation and interactions, online purchases, information requests, and sign-ups obtained from web server access log files, tracking pixels on website and app properties, and third party data sources that track digital activity including internet service providers, VPN, and software providers. Digital activity (at a minimum) may be required to include timestamp, event type or action details, mobile device identifier and/or IP address. Such data is normalized, ingested, and stored with these attributes so that it identifies the digital activity and allows it to be linked to other data sources for out-of-home advertising campaign analysis.

As described above, data ingestion for all sources occurs through a pre-setup process for each data source that identifies the format the data will be delivered (typically compressed JSON or CSV files), the schema of the data, and the key(s) that will allow it to be linked and added to a central combined relational database (the “Graph”). A process will determine when new data is ready for ingestion based upon polling a file storage location for new files or receiving a notification from a file storage location source that new file(s) have been added. The process will then identify the file(s) source based on naming convention and metadata and/or file storage location. The process will then extract (using the schema) and import and store the data into the central “Graph” database using the key(s).

Further, as used herein, the centralized relational database “Graph” is used to link all data from offline, online, and out-of-home. The Graph database contains a hierarchy of data keys with a household being at the top and a mobile device being a child entity of the household. Household attributes may include digital IP address, physical street address, GPS location coordinates, and all linked and ingested data. Similarly, Mobile Device attributes may include the mobile device identifier, and all linked online and physical tracked activity that is ingested into the Graph.

Mobile Devices are linked to a household by a process that analyzes online activity to ascertain the primary home (“Household”) IP address of any mobile device identifier based on primary and most recent activity with filters to exclude non-commercial based IP addresses and activity.

As described above, step 606 provides the process for generating advertising measurements and analytics. Such processes may be software programs that run on a predefined schedule (e.g., daily at midnight) and can also be triggered to run in real time based on any event (such as new data becoming available or a user interface request for a report). The processes compute metrics for an advertiser's out-of-home ad campaign based on ingested data for ad exposures, business points of interest visitation, and online digital activity joined together via the Graph. Computations include summation, relative percentage, averages, extrapolation of a subset to a full data set, attribution of multiple events (such as ad exposure and subsequent web visit or store visit). Generated metrics may include those related to the Reach and Frequency of Advertising, Web or App Visitation, Conversion Analysis and Lift, App Download and Conversion Analysis and Lift, Cost Per Web Visit, Cost Per Sale, Return on Ad Spend Analysis, Foot Traffic Analysis and Lift, Consumer Packaged Goods ROI and Sales Lift, Third Party Data Event Analysis and Lift

In one or more embodiments, the processing step 604 may also include the generation of the Graph. Such Graph generation may further include linking the input data at a household level and a mobile device level. With such linking/processing: (i) the mobile device can only belong to the first household; (ii) the mobile device is assigned to the first household based on digital activity data that identifies the first household (which may be a “primary” household) using a recent activity threshold with a filter that excludes non-commercial internet protocol (IP) addresses; (iii) the mobile device is identified through a mobile advertising device identifier (MAID); (iv) the one or more household attributes identify the first household and enable a physical address to link to an IP address; (v) an IP address for the first (e.g., primary) household is linked to the MAID for online digital activity and out-of-home activity; and (vi) a household street address is used to link offline activity. Further, the input data may be normalized, linked, and stored in the Graph. In addition, metrics and analytics may be computed by querying the Graph.

In other words, the Graph generation provides for creating an out-of-home relation database “Graph” that links data sources and bridges offline, online, and physical advertising data. The Graph links data at two primary levels: Household and Mobile Device. A Mobile Device can only belong to one primary Household and is assigned based on analysis of digital activity data to identify the primary Household (via IP address) using most recent activity thresholds with filters excluding non-commercial based IP addresses. Mobile Devices are identified through a Mobile Advertising Device Identifier (MAID) which is a consumer friendly opt-in unique device string of numbers and letters that identify the device. Households contain attributes that identify the Household and allow for linking data sources, namely: IP Address, Physical Street Address, GPS latitude/longitude coordinates. Physical Street Address and IP Address are linked through online consumer inputs including purchases, signup, and registration data, as well as through mobile device geotemporal data including GPS coordinates that map to a street address. In one or more embodiments, the Household IP Address and MAID may be the common links for most online digital activity. Further, the Household street address may be the common link for most offline activity. In addition, the Mobile Device associated to Household may be the link for most out-of-home activity.

When generating the Graph, data from all sources may be normalized, linked, and stored for processing including computing metrics and analytics. Further to the above, the Graph is the relational database that stores all offline, online, and out-of-home advertising related data and enables joining all the data sources together based on common keys. The Graph has processes to support the ingestion of new data through a pre-setup process for each data source that identifies the format the data will be delivered (typically compressed JSON or CSV files), the schema of the data, and the key(s) that will allow it to be linked and added to the Graph. A process will determine new data is ready for ingestion based upon polling a file storage location for new files or receiving a notification from a file storage location source that new file(s) have been added. The process will then identify the file(s) source based on naming convention and metadata and/or file storage location. The process will then extract (using the schema) and import and store the data into the central “Graph” database using the key(s). The Graph supports running queries to compute metrics and analytics related to out-of-home advertising including Reach and Frequency of Advertising, Web and App Visitation and Conversion Analysis and Lift, AppDownload and Conversion Analysis and Lift, Cost Per Web Visit, Cost Per Sale, Return on Ad Spend Analysis, Foot Traffic Analysis and Lift, Consumer Packaged Goods ROI and Sales Lift, Third Party Data Event Analysis and Lift through summation, relative percentage, averages, extrapolation of a subset to a full data, and attribution of multiple events (such as ad exposure and subsequent web visit or store visit).

Steps 604 and 606 may also include a determination of physical out-of-home advertising exposure and business location foot traffic visitation, e.g., by ingesting and processing geotemporal mobile device data to determine that a mobile device user was exposed to an out-of-home advertisement or visited a business location. The determining that the mobile device was exposed to an out-of-home advertisement may further include determining that the mobile device is within a location of the out-of-home advertisement at a time the out-of-home advertisement was played based on latitude and longitude tracking of the mobile device, screen size of the out-of-home advertisement, screen direction, ad duration, device dwell time and bearing. The determining that the mobile device visited a business location may include determining that the mobile device is within a geofence boundary of the business location for a threshold based period of time. Further, the determination of physical out-of-home advertising exposure and business location foot traffic visitation may include ingesting a WiFi access point, Bluetooth beacon, and other sensor data to determine if the mobile device was connected to or within a geofence boundary of an out-of-home advertisement or business location.

Alternatively, the determining physical out-of-home advertising exposure and business location foot traffic visitation may include ingesting interaction data for direct interaction with advertisements, wherein the direct interaction data consists of the scanning of QR codes, visiting a custom webpage, or calling or texting custom phone number.

In another embodiment, the determining physical out-of-home advertising exposure and business location foot traffic visitation may include ingesting coupon data, product registration data, or a loyalty and program use data to determine if a store or point of sale was visited. Such coupon data is for a coupon that is linked to a unique consumer and that was used at the business location. The product registration data may be from a consumer that visited the business location. In addition, the loyalty and reward program use data is for use of a loyalty and reward program at the business location.

Further details regarding the determining the physical out-of-home advertising exposure and business location (foot traffic) visitation are described below. Specifically, the ingestion and processing of geotemporal mobile device data may be used to determine that a mobile device user was exposed to an out-of-home advertisement or visited a business location. For ad exposures, mobile devices identified that are in the location of the advertising at the time of the ad play based on latitude and longitude tracking of the device, screen size of the ad, screen direction, ad duration, device dwell time and bearing being taken into consideration to determine exposure (e.g., using methods from the “DOOH Exposure Methodology Standardization Guidelines and Best Practices” (May 2021). For business location visits, mobile devices identified that are in the geofence boundaries of a location (e.g., for brick and mortar stores within the interior walls of the store) for a threshold based period of time determined by the advertiser (for example, retail advertiser threshold of a minimum of 2 minutes). Further embodiments may include the ingestion of WiFi access point, Bluetooth beacon, and other sensor data to determine if a mobile device user was connected to or in within the immediate geofence of an out-of-home advertisement or business location. For example, such data may be used to determine if a user is connected to or was in close connection proximity to an access point, beacon, or sensor indicating they were within the interior geofence of the business location for a threshold period of time (based on the advertiser and business location type, e.g., retail 2 minutes).

Further embodiments may also include the ingestion of direct interaction with advertisements including the scanning of QR codes, visiting custom webpage, calling or texting custom phone number. Additional data ingestion may include ingestion of data from coupons, product registrations, loyalty and rewards program use, and other advertiser marketing data to determine if a store or point of sale/interest was visited. For example, such ingestion may be used to determine the use of a coupon linked to a unique consumer that was used at a business location, product registration and/or customer satisfaction surveys (offline or online) from a consumer that visited a business location, and/or loyalty, rewards, or membership program use at business location. In particular, any of the above criteria can be used to conclude an out-of-home advertising exposure or business location visit occurred.

Step 606 may also include the extrapolation of a subset of consumers to a full population. For example, embodiments of the invention may determine that a subset of consumers are exposed to the delivered media content, determine a total market size and a percentage of a geographic population with mobile device penetration, and then extrapolate a full population based on the subset of consumers, total market size, and percentage of a geographic population with mobile device penetration. More specifically, in many circumstances only a subset of the out-of-home advertisement's campaign's exposure and business location visits are available, due mainly to consumers that do not opt-in to geotemporal tracking through any apps, cellular service providers, etc. or consumers not connecting to other access points or beacons actively or passively or using any other methods to identify activities described above. The exposed subset of consumers may be used to extrapolate a full population based on knowing the Total Market Size (from geographical related census data and third party data figures such as a billboard company measuring the total consumers who walked by their billboard in a 24 hour period of time) and the percentage of the geographical population with a mobile device (“Mobile Penetration”). The formula for a modeling Extrapolation Factor rate is: (Exposed Subset*Mobile Penetration %)/Total Market Size. The Extrapolation Factor rate is used by multiplying the exposed subset of a specific metric by (100%−the Extrapolation Factor) to model full population metrics including Reach, Return on Investment (Return on Ad Spend), and Cost per Conversion metrics to have holistic metrics and bring alignment and comparison with other advertising channels.

Step 606 may also include generating one or more out-of-home advertising control groups from the Graph. In this regard, a randomized control group (of the out-of-home advertising control groups) may be established (where the randomized control group provide a randomly selected nationwide audience with common demographic and psychographic profiles of an exposed population being measured). In addition, a similarity control group (of the out-of-home advertising control groups) may be established as an audience that exists in a same market as the digital content displayed with common demographic and psychographic profiles of the exposed population being measured. Thereafter, the measurements may provide a lift of the increase in sales that compares the exposed population being measured to the randomized control group and the similarity control group. In other words, control groups are established from the “Graph” to compare advertisement effectiveness for out-of-home campaigns between consumers and households exposed to the out-of-home ads against those that were not exposed. The randomized control groups are randomly selected nationwide audiences with similar demographic and psychographic profiles of the exposed population being measured. In one or more embodiments, each control group may consists of 1 million consumers and households. Further, similarity control groups are market level (exist in the same market as the ads were displayed) audiences with similar demographic and psychographic profiles of exposed population being measured. Such control groups may also consist of up to 1 million consumers and households and may be less if the market population is less than 1 million. The generated metrics for “Lift” (the increase in sales in other goals) may use a comparison of the exposed group to a control group in order to determine how much (if any) increase (as a percentage) in a goal occurs from the exposed group.

Step 606 may also include determining an out-of-home advertising lift. The lift may use an out-of-home ad exposed group and a non-exposed control group to calculate a percentage increase in business goals as a result of exposure to out-of-home media content for the purpose of measuring out-of-home advertising campaign effectiveness. In other words, embodiments of the invention may use an out-of-home ad exposed group and non-exposed control group(s) to calculate a percentage increase in business goals as a result of exposure to out-of-home advertising for the purpose of measuring out-of-home advertising campaign effectiveness. The formula used may be:

(Exposed Group Goal Completion Percentage−Control Group Goal

Completion Percentage)/Control Group Goal Completion Percentage Examples may include Website or App Visitation Rate lift from exposed Out-of-Home advertising consumers vs control group(s), Online Purchase Rate lift from exposed from exposed Out-of-Home advertising consumers vs control group(s), Business Location Visitation Rate lift from exposed Out-of-Home advertising consumers vs control group(s).

Step 606 may also include generating an out-of-home targeting group. The targeting group may be generated by processing out-of-home media content exposure to mobile devices to create a targeting segment. Such a targeting segment may consist of a group of users identified by Mobile Device Identifiers or linked Household IP address. The group of users may include one or more out-of-home tracked media content exposure consumers based on filtering criteria. The targeting segment is then used to re-message or re-expose the group of users in the targeting segment to an ad campaign on multiple platforms. The media content provider selects a platform of the multiple platforms and a format for outputting the targeting segment. The output targeting segment is input in the format to the selected platform. to perform the re-messaging or re-exposing. In other words, embodiments of the invention may provide for processing out-of-home ad exposure mobile devices to create targeting segments. As used herein, targeting segments are groups of users identified by Mobile Device Identifier and/or linked Household IP address (in some cases, exposed mobile devices need to be joined to Households using the Graph in order to obtain the Household IP address and use that for targeting depending on the platform and device type, e.g., to target users on Connected TVs). Targeting segments are all or a subset of the out-of-home tracked ad exposure consumers based on applying or not applying filtering criteria such as devices that were only exposed to the ad once. The segments are primarily used to “Retarget” which is to re-message or re-expose the user to the ad campaign on other platforms such as social media ads, web or app based digital online ads, connected TV ads, etc. Targeting segments are formatted to be able to run ad campaign on various platforms and targeting various device types by a user selecting the platform and format in a user interface and a subsequent process using that input to create the targeting segment output as a CSV export file for the user to then upload in a complimentary ad platform to reach the exposed consumers. For example, the output of a targeting group for connected TV ads may be a CSV file of Household IP addresses and the output for a social media platform may be a CSV file of MAIDs.

Step 606 may also include attributing out-of-home advertiser digital action events to physical advertising events. Such attribution may include ingesting the physical out-of-home activity data. For example, web server log files may be processed to extract digital action event data for the out-of-home advertiser digital action events. Thereafter, tracking data is deployed and ingested from tracking pixels on out-of-home advertiser digital properties. Such tracking data may represent the out-of-home advertiser digital action events. Further, third party data from out-of-home advertiser's digital property may be processed (where the third party data represents the out-of-home advertiser digital action events). The physical out-of-home ad exposure and business location visitation foot traffic data is then processed to determine the one or more households with physical ad exposures or business location visits. The input data processing consists of linking the out-of-home advertiser digital action events to the one or more households via the Graph with the key, and linking out-of-home advertising consumer exposures to the one or more households via the Graph with the key. The measurements may then be generated by determining that a consumer has been exposed to an advertisement followed by completing a digital action within a defined period of time after being exposed to the advertisement, In this regard, based on the determining that the consumer has been exposed, the out-of-home advertiser digital action events may be attributed to the physical advertising events.

Details for determining the above attribution follows. Specifically, web server log files are processed to extract (at a minimum) timestamp of event, event type or action details (such as website visit or online purchase), mobile device identifier and/or IP address which can be used to represent digital action events. Tracking pixels may then be deployed and resulting data ingested for out-of-home advertiser digital properties that collect and store data including (at a minimum) timestamp, event type or action details, mobile device identifier and/or IP address which can be used to represent digital action events. The processing of third party data further provides events from out-of-home advertiser's digital property and includes timestamp, event type of action details, mobile device identifier and/or IP address which can be used to represent digital action events. The processing of physical out-of-home ad exposure and business location visitation (foot traffic) data is used to determine households with physical ad exposures and/or business location visits. Online digital events are linked to Households via the “Graph” with a common key of Household IP address or Mobile Device Identifier. Further, out-of-home advertising consumer exposures are linked to Households via the “Graph” with a common key, Mobile Device Identifier. Online actions may then be attributed to the advertiser's out-of-home campaign based on analyzing data that the consumer that generated a digital action was exposed to one or more of the advertiser's out-of-home ads, when they were exposed, and when the action occurred. In order to attribute the digital action to the out-of-home ad, the consumer must have been exposed to the advertisement first and then thereafter complete the digital action within a certain period of time after the advertisement exposure (Lookback Days) (“Lookback Days” also known as “Lookback Windows” represent how long after an ad exposure to attribute subsequent consumer actions).

Step 606 may also include attributing out-of-home advertiser foot traffic physical business location visitation events to out-of-home advertising exposures. Attribution steps may include determining that a consumer has been exposed to an out-of-home advertisement, determining that the consumer generated a physical location event, and determining that the physical location event was generated within a defined period of time subsequent to the consumer being exposed to the out-of-home advertisement. Thereafter, based on the determining that the physical location event was generated within the defined period of time subsequent to the consumer being exposed, the physical location event may be attributed to the out-of-home advertisement.

Details for the attribution of out-of-home advertiser foot traffic physical business location visitation events to out-of-home advertising exposures follow. Specifically, physical out-of-home advertiser business location visitation events may be attributed to the advertiser's out-of-home ad campaign based on analyzing data that the consumer that generated a physical location event was exposed to one or more of the advertiser's out-of-home ads, when they were exposed, and when the foot traffic location event occurred. In order to attribute the foot traffic event to the out-of-home ad, the consumer must have been exposed to the advertisement first and then thereafter visit the advertiser's business location(s) within a certain period of time after the advertisement exposure (Lookback Days) (“Lookback Days” also known as “Lookback Windows” represent how long after an ad exposure to attribute subsequent consumer actions and events).

### Hardware Environment

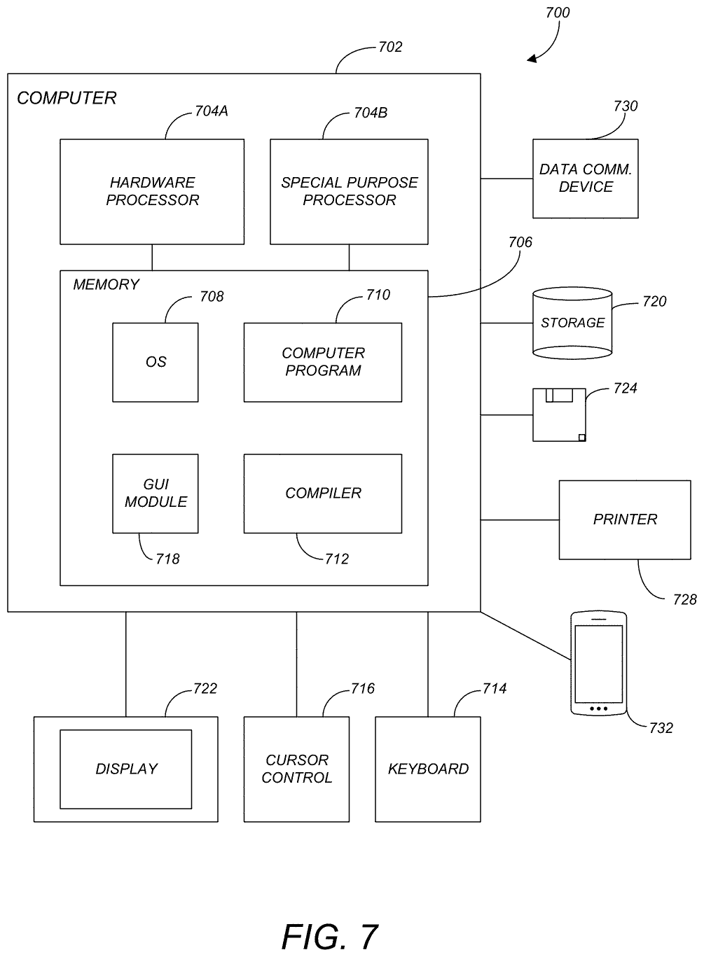

FIG. 7 is an exemplary hardware and software environment 700 (referred to as a computer-implemented system and/or computer-implemented method) used to implement one or more embodiments of the invention. The hardware and software environment includes a computer 702 and may include peripherals. Computer 702 may be a user/client computer, server computer, or may be a database computer. The computer 702 comprises a hardware processor 704A and/or a special purpose hardware processor 704B (hereinafter alternatively collectively referred to as processor 704) and a memory 706, such as random access memory (RAM). The computer 702 may be coupled to, and/or integrated with, other devices, including input/output (I/O) devices such as a keyboard 714, a cursor control device 716 (e.g., a mouse, a pointing device, pen and tablet, touch screen, multi-touch device, etc.) and a printer 728. In one or more embodiments, computer 702 may be coupled to, or may comprise, a portable or media viewing/listening device 732 (e.g., an MP3 player, IPOD, NOOK, portable digital video player, cellular device, personal digital assistant, etc.). In yet another embodiment, the computer 702 may comprise a multi-touch device, mobile phone, gaming system, internet enabled television, television set top box, or other internet enabled device executing on various platforms and operating systems.

In one embodiment, the computer 702 operates by the hardware processor 704A performing instructions defined by the computer program 710 (e.g., a computer-aided design [CAD] application) under control of an operating system 708. The computer program 710 and/or the operating system 708 may be stored in the memory 706 and may interface with the user and/or other devices to accept input and commands and, based on such input and commands and the instructions defined by the computer program 710 and operating system 708, to provide output and results.

Output/results may be presented on the display 722 or provided to another device for presentation or further processing or action. In one embodiment, the display 722 comprises a liquid crystal display (LCD) having a plurality of separately addressable liquid crystals. Alternatively, the display 722 may comprise a light emitting diode (LED) display having clusters of red, green and blue diodes driven together to form full-color pixels. Each liquid crystal or pixel of the display 722 changes to an opaque or translucent state to form a part of the image on the display in response to the data or information generated by the processor 704 from the application of the instructions of the computer program 710 and/or operating system 708 to the input and commands. The image may be provided through a graphical user interface (GUI) module 718. Although the GUI module 718 is depicted as a separate module, the instructions performing the GUI functions can be resident or distributed in the operating system 708, the computer program 710, or implemented with special purpose memory and processors.

In one or more embodiments, the display 722 is integrated with/into the computer 702 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 702 according to the computer program 710 instructions may be implemented in a special purpose processor 704B. In this embodiment, some or all of the computer program 710 instructions may be implemented via firmware instructions stored in a read only memory (ROM), a programmable read only memory (PROM) or flash memory within the special purpose processor 704B or in memory 706. The special purpose processor 704B may also be hardwired through circuit design to perform some or all of the operations to implement the present invention. Further, the special purpose processor 704B may be a hybrid processor, which includes dedicated circuitry for performing a subset of functions, and other circuits for performing more general functions such as responding to computer program 710 instructions. In one embodiment, the special purpose processor 704B is an application specific integrated circuit (ASIC).

The computer 702 may also implement a compiler 712 that allows an application or computer program 710 written in a programming language such as C, C++, Assembly, SQL, PYTHON, PROLOG, MATLAB, RUBY, RAILS, HASKELL, or other language to be translated into processor 704 readable code. Alternatively, the compiler 712 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 710 accesses and manipulates data accepted from I/O devices and stored in the memory 706 of the computer 702 using the relationships and logic that were generated using the compiler 712.

The computer 702 also optionally comprises an external communication device such as a modem, satellite link, Ethernet card, or other device for accepting input from, and providing output to, other computers 702.

In one embodiment, instructions implementing the operating system 708, the computer program 710, and the compiler 712 are tangibly embodied in a non-transitory computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of computer program 710 instructions which, when accessed, read and executed by the computer 702, cause the computer 702 to perform the steps necessary to implement and/or use the present invention or to load the program of instructions into a memory 706, thus creating a special purpose data structure causing the computer 702 to operate as a specially programmed computer executing the method steps described herein. Computer program 710 and/or operating instructions may also be tangibly embodied in memory 706 and/or data communications devices 730, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 702.

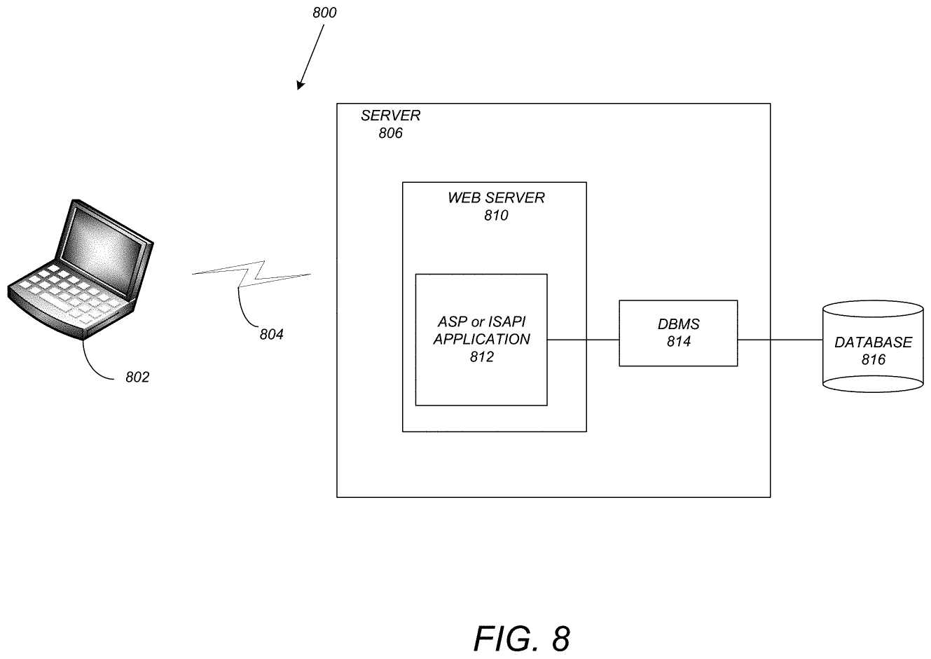

FIG. 8 schematically illustrates a typical distributed/cloud-based computer system 800 using a network 804 to connect client computers 802 to server computers 806. A typical combination of resources may include a network 804 comprising the Internet, LANs (local area networks), WANs (wide area networks), SNA (systems network architecture) networks, or the like, clients 802 that are personal computers or workstations (as set forth in FIG. 7), and servers 806 that are personal computers, workstations, minicomputers, or mainframes (as set forth in FIG. 7). However, it may be noted that different networks such as a cellular network (e.g., GSM [global system for mobile communications] or otherwise), a satellite based network, or any other type of network may be used to connect clients 802 and servers 806 in accordance with embodiments of the invention.

A network 804 such as the Internet connects clients 802 to server computers 806. Network 804 may utilize ethernet, coaxial cable, wireless communications, radio frequency (RF), etc. to connect and provide the communication between clients 802 and servers 806. Further, in a cloud-based computing system, resources (e.g., storage, processors, applications, memory, infrastructure, etc.) in clients 802 and server computers 806 may be shared by clients 802, server computers 806, and users across one or more networks. Resources may be shared by multiple users and can be dynamically reallocated per demand. In this regard, cloud computing may be referred to as a model for enabling access to a shared pool of configurable computing resources.

Clients 802 may execute a client application or web browser and communicate with server computers 806 executing web servers 810. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 802 may be downloaded from server computer 806 to client computers 802 and installed as a plug-in or ACTIVEX control of a web browser. Accordingly, clients 802 may utilize ACTIVEX components/component object model (COM) or distributed COM (DCOM) components to provide a user interface on a display of client 802. The web server 810 is typically a program such as MICROSOFT'S INTERNET INFORMATION SERVER.

Web server 810 may host an Active Server Page (ASP) or Internet Server Application Programming Interface (ISAPI) application 812, which may be executing scripts. The scripts invoke objects that execute business logic (referred to as business objects). The business objects then manipulate data in database 816 through a database management system (DBMS) 814. Alternatively, database 816 may be part of, or connected directly to, client 802 instead of communicating/obtaining the information from database 816 across network 804. When a developer encapsulates the business functionality into objects, the system may be referred to as a component object model (COM) system. Accordingly, the scripts executing on web server 810 (and/or application 812) invoke COM objects that implement the business logic. Further, server 806 may utilize MICROSOFT'S TRANSACTION SERVER (MTS) to access required data stored in database 816 via an interface such as ADO (Active Data Objects), OLE DB (Object Linking and Embedding DataBase), or ODBC (Open DataBase Connectivity).

Generally, these components 800-816 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 802 and 806 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 802 and 806. Embodiments of the invention are implemented as a software/CAD application on a client 802 or server computer 806. Further, as described above, the client 802 or server computer 806 may comprise a thin client device or a portable device that has a multi-touch-based display.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for delivering media content comprising:
(a) ingesting input data, wherein:
(i) the ingesting input data comprises ingesting raw data, wherein the raw data comprises:
(1) one or more household locations for one or more households, wherein each household location comprises a mapping between a physical street address to global positioning satellite (GPS) coordinates;
(2) marketing data comprising demographic income and interests data;
(ii) the ingesting input data comprises ingesting physical out-of-home activity data from advertisement exposure and business points of interest visitation, wherein the ingesting the physical out-of-home activity data comprises:
(1) normalizing the physical out of home activity data with a mobile device identifier as a key, wherein the mobile device identifier is for a mobile device;
(iii) the ingesting input data comprises ingesting digital internet based online activity data, wherein the digital internet based online activity data comprises a timestamp, an event type or action details, and the mobile device identifier or an IP address, wherein the ingesting comprises:
(1) normalizing the digital internet based online activity data with the mobile device identifier as the key;
(iv) the ingesting the input data is performed through a pre-setup process;
(v) the pre-setup process identifies a data delivery format, a data schema, and the key that will link respective data in a Graph within a central combined relational database;
(b) processing the input data by:
(i) determining when new data is ready for ingestion based upon polling a file storage location for new files or receiving a notification from a file storage location source that a new file has been added;
(ii) identifying a file source;
(iii) extracting, using the data schema, the input data from the file source;
(iv) importing and storing the extracted input data into the Graph using the key;
(v) linking the input data in the Graph, wherein the Graph comprises:
(1) a hierarchy of data keys with a first household of the one or more households at a top of the hierarchy and the mobile device being a child entity of the first household;
(2) one or more household attributes for the first household;
(3) one or more mobile device attributes, wherein the mobile device attributes comprise the mobile device identifier and all linked online and physical tracked activity that is ingested into the Graph; and
(4) a link between the mobile device and the first household;
(c) generating measurements and analytics for delivered media content based on the ingested input data, wherein the measurements and analytics comprise a measurement of exposure to the delivered media content; and
(d) iteratively updating, based on receipt of new input data, and utilizing a media content delivery system that delivers the media content based on the measurements and analytics, wherein the measurements and analytics are iteratively updated via the ingestion of the new input data.

2. The computer-implemented method of claim 1, further comprising generating the Graph, wherein the generating comprises:
(a) linking the input data at a household level and a mobile device level, wherein:
(i) the mobile device can only belong to the first household;
(ii) the mobile device is assigned to the first household based on digital activity data that identifies the first household using a recent activity threshold with a filter that excludes non-commercial internet protocol (IP) addresses;
(iii) the mobile device is identified through a mobile advertising device identifier (MAID);
(iv) the one or more household attributes identify the first household and enable a physical address to link to an IP address;
(v) an IP address for the first household is linked to the MAID for online digital activity and out-of-home activity;
(vi) a household street address is used to link offline activity;
(b) normalizing, linking, and storing the input data in the Graph; and
(c) computing metrics and analytics by querying the Graph.

3. The computer-implemented method of claim 1, further comprising determining physical out-of-home advertising exposure and business location foot traffic visitation.

4. The computer-implemented method of claim 3, wherein the determining physical out-of-home advertising exposure and business location foot traffic visitation comprises:
ingesting and processing geotemporal mobile device data to determine that a mobile device user was exposed to an out-of-home advertisement or visited a business location.

5. The method of claim 4, wherein the determining that the mobile device was exposed to an out-of-home advertisement comprises:
determining that the mobile device is within a location of the out-of-home advertisement at a time the out-of-home advertisement was played based on latitude and longitude tracking of the mobile device, screen size of the out-of-home advertisement, screen direction, ad duration, device dwell time and bearing.

6. The method of claim 4, wherein the determining that the mobile device visited a business location comprises:
determining that the mobile device is within a geofence boundary of the business location for a threshold based period of time.

7. The computer-implemented method of claim 3, wherein the determining physical out-of-home advertising exposure and business location foot traffic visitation comprises:
ingesting a WiFi access point, Bluetooth beacon, and other sensor data to determine if the mobile device was connected to or within a geofence boundary of an out-of-home advertisement or business location.

8. The computer-implemented method of claim 3, wherein the determining physical out-of-home advertising exposure and business location foot traffic visitation comprises:
ingesting interaction data for direct interaction with advertisements, wherein the direct interaction data comprises:
scanning of QR codes;
visiting a custom webpage; or
calling or texting custom phone number.

9. The computer-implemented method of claim 3, wherein the determining physical out-of-home advertising exposure and business location foot traffic visitation comprises ingesting coupon data, product registration data, or a loyalty and program use data to determine if a store or point of sale was visited, wherein:
the coupon data is for a coupon, wherein the coupon is linked to a unique consumer and the coupon was used at the business location;
the product registration data is from a consumer that visited the business location; and
the loyalty and reward program use data is for use of a loyalty and reward program at the business location.

10. The computer-implemented method of claim 1, wherein the generating measurements and analytics further comprises:
determining that a subset of consumers are exposed to the delivered media content;
determining a total market size and a percentage of a geographic population with mobile device penetration;
extrapolating a full population based on the subset of consumers, total market size, and percentage of a geographic population with mobile device penetration.

11. The computer-implemented method of claim 1, wherein:
the generating measurements and analytics further comprises generating one or more out-of-home advertising control groups from the Graph by:
establishing a randomized control group of the out-of-home advertising control groups, wherein the randomized control group comprises a randomly selected nationwide audience with common demographic and psychographic profiles of an exposed population being measured;
establishing a similarity control group of the out-of-home advertising control groups, wherein the similarity control group comprises an audience that exists in a same market as the digital content displayed with common demographic and psychographic profiles of the exposed population being measured;
the measurements comprise a lift of the increase in sales that compares the exposed population being measured to the randomized control group and the similarity control group.

12. The computer-implemented method of claim 1, wherein the generating measurements comprises determining an out-of-home advertising lift comprising:
using an out-of-home ad exposed group and a non-exposed control group to calculate a percentage increase in business goals as a result of exposure to out-of-home media content for the purpose of measuring out-of-home advertising campaign effectiveness.

13. The computer-implemented method of claim 1, wherein the generating measurements comprises generating an out-of-home targeting group by:
processing out-of-home media content exposure to mobile devices to create a targeting segment, wherein:
the targeting segment comprises a group of users identified by Mobile Device Identifiers or linked Household IP address;
the group of users comprises one or more out-of-home tracked media content exposure consumers based on filtering criteria;
the targeting segment is used to re-message or re-expose the group of users in the targeting segment to an ad campaign on multiple platforms;
a media content provider selects a platform of the multiple platforms;
the media content provider selects a format for outputting the targeting segment;
inputting the output targeting segment in the format to the selected platform to perform the re-messaging or re-exposing.

14. The computer-implemented method of claim 1, wherein the generating measurements comprises attributing out-of-home advertiser digital action events to physical advertising events, wherein:
the ingesting the physical out-of-home activity data comprises:
processing web server log files to extract digital action event data for the out-of-home advertiser digital action events;
deploying and ingesting tracking data from tracking pixels on out-of-home advertiser digital properties, wherein the tracking data represents the out-of-home advertiser digital action events;
processing third party data from out-of-home advertiser's digital property, wherein the third party data represents the out-of-home advertiser digital action events;
processing physical out-of-home ad exposure and business location visitation foot traffic data to determine the one or more households with physical ad exposures or business location visits;
the processing the input data comprises:
linking the out-of-home advertiser digital action events to the one or more households via the Graph with the key;
linking out-of-home advertising consumer exposures to the one or more households via the Graph with the key;
the generating the measurements comprises:
based on the above linking, determining that a consumer has been exposed to an advertisement followed by completing a digital action within a defined period of time after being exposed to the advertisement; and
attributing, based on the determining that the consumer has been exposed, the out-of-home advertiser digital action events to the physical advertising events.

15. The computer-implemented method of claim 1, wherein the generating measurements comprises attributing out-of-home advertiser foot traffic physical business location visitation events to out-of-home advertising exposures, comprising:
determining that a consumer has been exposed to an out-of-home advertisement;
determining that the consumer generated a physical location event;
determining that the physical location event was generated within a defined period of time subsequent to the consumer being exposed to the out-of-home advertisement; and
attributing, based on the determining that the physical location event was generated within the defined period of time subsequent to the consumer being exposed, the physical location event to the out-of-home advertisement.

16. A computer-implemented method for determining physical out-of-home advertising exposure and business location foot traffic visitation comprising:
ingesting and processing geotemporal mobile device data to determine that a mobile device user was exposed to an out-of-home advertisement or visited a business location, wherein:
the determining that mobile device user is exposed to an out-of-home advertisement when the mobile device is within a location of the out-of-home advertisement at a time the out-of-home advertisement was played based on latitude and longitude tracking of the mobile device, screen size of the out-of-home advertisement, screen direction, ad duration, device dwell time and bearing;
the determining that the mobile device visited a business location comprises determining that the mobile device is within a geofence boundary of the business location for a threshold based period of time;
updating a media content delivery campaign based on the determination that the mobile device user was exposed to the out-of-home advertisement or visited a business location, wherein the media content delivery campaign delivers media content based on the out-of-home advertisement to the mobile device user.

17. The computer-implemented method of claim 16, wherein the determining physical out-of-home advertising exposure and business location foot traffic visitation comprises:
ingesting a WiFi access point, Bluetooth beacon, and other sensor data to determine if the mobile device was connected to or within a geofence boundary of an out-of-home advertisement or business location.

18. The computer-implemented method of claim 16, wherein the determining physical out-of-home advertising exposure and business location foot traffic visitation comprises:
ingesting interaction data for direct interaction with advertisements, wherein the direct interaction data comprises:
scanning of QR codes;
visiting a custom webpage; or
calling or texting custom phone number.

19. The computer-implemented method of claim 16, wherein the determining physical out-of-home advertising exposure and business location foot traffic visitation comprises ingesting coupon data, product registration data, or a loyalty and program use data to determine if a store or point of sale was visited, wherein:
the coupon data is for a coupon, wherein the coupon is linked to a unique consumer and the coupon was used at the business location;
the product registration data is from a consumer that visited the business location; and
the loyalty and reward program use data is for use of a loyalty and reward program at the business location.
